(19) United States
(12) Patent Application Publication
(10) Pub. No.: US 2026/0266957 A1
(43) Pub. Date: Sep. 10, 2026

(54) LIDAR DEVICE AND EQUIPMENT USING THE SAME

(71) Applicant: AUTOX TECH PTE. LTD., SINGAPORE (SG)

(72) Inventors: Zhuo Li, Shenzhen (CN); Yizhou Shan, Shenzhen (CN)

(73) Assignee: AUTOX TECH PTE. LTD., SINGAPORE (SG)

(21) Appl. No.: 19/257,484

(22) Filed: Jul. 2, 2025

(30) Foreign Application Priority Data
Mar. 7, 2025 (CN) 202520405431X

(51) Int. Cl. G01S 7/481

(52) U.S. Cl. CPC G01S 7/4812; G01S 7/4813

(57) ABSTRACT

an emitter for emitting emission beams, and a receiver for detecting reflection beams, the reflection beams being beams reflected back by a target object after the emission beams travel to the target object; a transmitter mirror, reflects the emission beams to the lens assembly; a lens assembly, collimates the emission beams into a collimated beams and focuses the reflection beams onto the aperture-coupled mirror; an aperture-coupled mirror, reflects the received reflection beams to the receiver mirror; and a receiver mirror, reflects the reflection beams reflected by the aperture-coupled mirror to the receiver. The disclosure further provides a device. By providing the receiver mirror, the disclosure increases the path length of the reception path.

### CROSS REFERENCE TO RELATED APPLICATION

This non-provisional patent application claims priority under 35 U.S.C. §119 from Chinese Patent Application No. CN 202520405431.X filed on Mar. 7, 2025, the entire content of which is incorporated herein by reference.

### TECHNICAL FIELD

The disclosure relates to the field of LiDAR, and particularly to a LiDAR device and equipment using the same.

### BACKGROUND

LiDAR is an optical remote sensing technology that measures information such as distance, speed, and direction of a target object by emitting a laser beams to the target object and receiving the reflected optical signal. In autonomous driving and unmanned systems, LiDAR can generate high-precision point cloud data, including spatial position and reflection intensity of each point, providing rich environmental perception data for autonomous driving systems.

In the prior art, LiDAR generally uses a lens assembly to collimate the emitted laser beams and adjust the received laser beams. The received laser beams passing through the lens assembly is directly focused onto the receiver through an aperture-coupled mirror. However, the reception path through which the received laser beams are directly reflected to the receiver via the aperture-coupled mirror is short, which is not conducive to the receiver receiving the light spot.

### SUMMARY

In view of the above, the disclosure provides a LiDAR device and equipment to increase the path length of the reception path between the reflection beams adjusted by the lens assembly and the receiver, facilitating the receiver to receive the light spot.

In a first aspect, the disclosure provides a LiDAR device. The LiDAR device includes: a housing; and a transceiver, a lens assembly, a transmitter mirror, an aperture-coupled mirror, and a receiver mirror disposed inside the housing.

Further, the aperture-coupled mirror comprises a transparent region, and a reflective region, a part of the aperture-coupled mirror that is not transparent is the reflective region; the transparent region transmits the emission beams reflected by the transmitter mirror, and the reflective region reflects the reflection beams focused by the lens assembly.

Further, a transmission range of the transparent region corresponds to that of the emission beams reflected by the transmitter mirror.

Further, the transparent region is strip-shaped, and a length of the transparent region is about 99 mm~101 mm.

Further, the lens assembly comprises a plurality of spaced lenses arranged concentrically

Further, an entire surface of the lens assembly is illuminated by the emission beams.

Further, the LiDAR device is a single-lens LiDAR device, a focal length of the lens assembly is about 214 mm~216 mm, and a thickness of the lens assembly is about 74 mm~76 mm.

Further, the transceiver is a coaxial transceiver.

Further, the emitter is one or more, the receiver is one or more, and the emission beams emitted by the emitter are detected only by the corresponding receiver

In a second aspect, the disclosure further provides a device. The device includes: a main body; and the LiDAR device disposed on the main body.

In summary, by providing the receiver mirror, the disclosure reflects the reflection beams reflected by the aperture-coupled mirror to the receiver through the receiver mirror, thereby increasing the path length of the reception path between the reflection beams adjusted by the lens assembly and the receiver, and facilitating the receiver to receive the light spot.

### BRIEF DESCRIPTION OF THE DRAWINGS

FIG. 1 is a cross-sectional schematic diagram of a LiDAR device in accordance with an embodiment.

FIG. 2 is a structural schematic diagram of a device in accordance with an embodiment.

### REFERENCE NUMERALS IN THE FIGURES

Device 100; Main body 200; LiDAR device 300; Housing 10; Lens assembly 20; lens assembly 201; Transceiver 30; Emitter 301; Receiver 302; Transmitter Mirror 40; Receiver Mirror 50; Aperture-Coupled Mirror 60; Transparent Region 601; Reflective Region 602 Internal Space 70; First Path 80; Second Path 81; Emission Path 90 Reception Path 91.

The realization of the objectives, functional features, and advantages of the disclosure will be further described with reference to the embodiments and the accompanying drawings.

### DETAILED DESCRIPTION OF THE EMBODIMENTS

In the description of the present application, it should be understood that the terms “length,” “width” “up,” “down,” “front,” “rear,” “left,” “right,” “vertical,” “horizontal,” “top,” “bottom,” “inner,” “outer,” and other similar terms indicating orientation or positional relationships are based on the orientation or positional relationships depicted in the accompanying drawings. These terms are solely for the purpose of facilitating the description of the present application and simplifying the description, and are not intended to indicate or imply that the devices or elements referred to must have specific orientations, be constructed or operated in specific orientations. Therefore, they should not be construed as limitations of the present application.

Furthermore, the terms “firs” and “second” are used solely for descriptive purposes and cannot be understood as indicating or implying relative importance or the number of technical features implied by the indication. Consequently, features qualified by “first” and “second” may explicitly or implicitly include one or more of such features. In the description of the present application, the term “plurality” means two or more, unless otherwise specifically and definitely limited.

In the present application, unless otherwise specifically defined and limited, terms such as “install,” “connect,” “link,” “fix,” and their derivatives should be broadly interpreted. For example, they may refer to fixed connections, detachable connections, or integration; mechanical connections or electrical connections; direct connections or indirect connections through intermediary media; internal communication between two elements or interaction between two elements. For those skilled in the art, the specific meanings of these terms in the context of the present application can be understood based on specific circumstances.

To provide a clearer and more accurate understanding of the content of the present application, a detailed description will now be provided in conjunction with the accompanying drawings. The drawings illustrate examples of embodiments of the present application, wherein identical numerals indicate identical elements. It should be understood that the proportions shown in the drawings are not to scale and are solely for illustrative purposes.

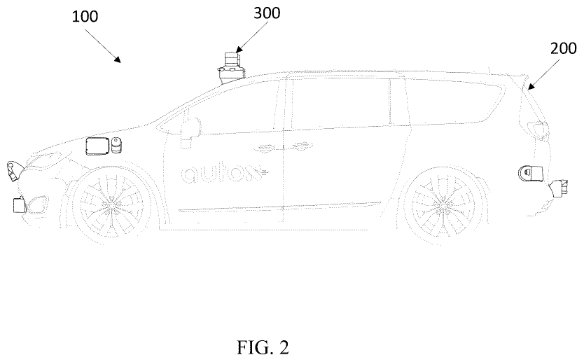

Referring to FIG. 2, the disclosure provides a device 100. The device 100 is applicable to multiple fields, including but not limited to the transportation field, meteorological field, and civil aviation field. The device 100 may be a weather radar, an agricultural detection radar, a traffic flow detection radar, etc. In this embodiment, the device 100 includes a main body 200 and a LiDAR device 300 mounted on the main body 200. The device 100 can improve people's work efficiency and quality of life through the LiDAR device 300.

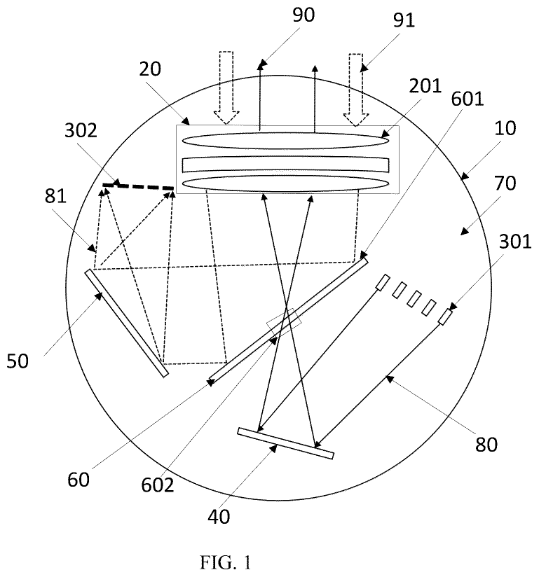

Referring to FIG. 1, the disclosure provides a LiDAR device 300. In this embodiment, the LiDAR device 300 may be mounted on a wall of a building structure, such as a wall, corridor, etc., or on the housing of a device 100, such as the housing of a car, detector, etc. The LiDAR device 300 is configured to sense information of a target object in the space where the object is located.

The LiDAR device 300 includes a housing 10, a lens assembly assembly 20, a transceiver 30, an transmitter mirror 40, a receiver mirror 50, and an aperture-coupled mirror 60. The housing 10 is provided with an internal space 70, and the transceiver 30, the lens assembly 20, the transmitter mirror 40, the aperture-coupled mirror 60, and the receiver mirror 50 are detachably mounted in the internal space 70. In this embodiment, the LiDAR device 300 is a single-lens LiDAR device. The transceiver 30 is configured to emit emission beams and detect reflection beams to detect information of a target object at a preset detection position corresponding to the emission and reception directions. The transmitter mirror 40 is configured to change the path of the emission beams. The receiver mirror 50 is configured to change the path of the reflection beams. The aperture-coupled mirror 60 is configured to reflect the reflection beams to the receiver mirror 50. The transceiver 30 emits the emission beams, which are reflected by the transmitter mirror 40 to the aperture-coupled mirror 60, passes through the aperture-coupled mirror 60 and propagates to the lens assembly 20, and the lens assembly 20 collimates the divergence angle of the emission beams to form parallel light (see the first path 80) to detect information of a target object corresponding to the emission direction. The emission beams are reflected by the target object to form a reflection beams, which enter the internal space 70 through the collimation of the lens assembly 20, passes through the aperture-coupled mirror 60 and the receiver mirror 50, and are reflected to the transceiver 30 (see the second path 81) to acquire information of the target object.

The transceiver 30 includes one or more emitters 301, and one or more receivers 302. Each emitter 301 corresponds to at least one receiver 302, and the emission beams emitted by the emitter 301 are detected only by the corresponding receiver 302. Specifically, the emitters 301 are arranged at predetermined angles of emission channels and are configured to emit beams into a field of view space to detect three-dimensional information of a target object in the field of view space. Part of the beams are reflected back by the target object to form beams echoes. The receivers 302 are arranged at predetermined angles of reception channels and are configured to sense photons from the field of view range and output corresponding optical sensing signals. It should be understood that the optical signals sensed by the receivers 302 may include photons reflected back by the target object in the field of view range (beams echoes) and photons of ambient light in the field of view range. In this embodiment, the transceiver is a coaxial transceiver, i.e., the optical paths of the emission beams and the reflection beams coincide. By setting the central axes of the emission and reception optical paths on the same line instead of two separate parallel lines, the disclosure solves the problem of optical blind zones and degraded performance caused by binocular parallax in close proximity situations, facilitates channel calibration, and reduces the area of the lens assembly 20 with the same optical aperture. The transceiver 30 may be an EEL laser (Edge Emitting Laser) or a VCSEL laser (Vertical Cavity Surface Emitting Laser), etc.

The housing 10 is configured to protect the components of the LiDAR device 300 and provide storage space for the components of the LiDAR device 300. The housing 10 may be made of plastic, metal, or other materials. In this embodiment, the housing 10 is a spherical structure. In some embodiments, the surface of the housing 10 is coated with electromagnetic shielding material to reduce electromagnetic noise around the LiDAR device 300, thereby improving the quality of the emission beams emitted by the emitter 301 and reducing noise in the signal received by the receiver 302. The electromagnetic shielding material is a material capable of absorbing electromagnetic radiation and may be metal, carbon foam, metal ink, etc.

The single lens assembly 20 is disposed inside the housing 10, and the lens assembly 20 includes a plurality of spaced lenses 201 arranged concentrically. the lens assembly 20 is configured to configure optical parameters of the emission beams and the reflection beams, so that the emission beams are collimated into a parallel beams (see the emission path 90) to detect the target object. In this embodiment, the lens assembly 20 is close to the housing 10, and the receiver 302 and the lens assembly 20 are located on the same side. The portion of the housing 10 corresponding to the top of the lens assembly 20 is made of a light-transmitting material. The reflection beams reflected back by the target object enters the lens assembly 20 in the form of parallel light (see the reception path 91) and covers the entire surface of the lens assembly 20. Each lens assembly 201 has a focal length of 214 mm~216 mm, and the thickness of the lens assembly 20 is 74 mm~76 mm. The beams emitted by the emitter 301 and the beams received by the receiver 302 are collimated through the same lens assembly 20. By providing a single lens assembly 20 in the internal space 70 of the housing 10, the disclosure reduces the weight of the LiDAR device 300 and increases the aperture of the lens assembly 20 to improve the ranging capability and other indicators of the LiDAR device 300.

The aperture-coupled mirror 60 is configured to achieve coaxial emission and reception optical paths. In this embodiment, the aperture-coupled mirror 60 is disposed between the lens assembly 20 and the transceiver 30. The aperture-coupled mirror 60 includes a reflective region 601 and a transparent region 602. In this embodiment, the aperture-coupled mirror 60 is strip-shaped, the transparent region 601 is disposed in the middle of the aperture-coupled mirror 60, a part of the aperture-coupled mirror 60 that is not transparent is the reflective region 602, and the transmission range of the transparent region 601 corresponds to the range of the emission beams reflected by the transmitter mirror 40. In this embodiment, the length of the transparent region 601 is 99 mm~101 mm. The transparent region 601 is made of a light-transmitting material, such as crystal or glass, for transmitting the laser beams. The reflective region 602 is made of a highly reflective material, such as an optical reflective film, optical fiber, or metal, for adjusting the propagation of the beams received by the receiver 302 along a preset path.

The transmitter mirror 40 is configured according to the structural and dimensional requirements of the LiDAR device 300. In this embodiment, the transmitter mirror 40 is disposed opposite to the emitter 301 so that the beams emitted by the emitter 301 can be reflected by the transmitter mirror 40 to the aperture-coupled mirror 60. Specifically, the beams emitted by the emitter 301 propagates to the transmitter mirror 40, which reflects the received emission beams to the transparent region 601 of the aperture-coupled mirror 60 along a preset path. The emission beams pass through the transparent region 601 and propagates to the lens assembly 20. The emission beams entering the lens assembly 20 are collimated by the plurality of lenses 201 to correct the divergence angle of the emission beams and form a parallel beams (see the emission beams 80).

The receiver mirror 50 is configured according to the structural and dimensional requirements of the LiDAR device 300. In this embodiment, the receiver mirror 50 is disposed opposite to the reflective region 602 of the aperture-coupled mirror 60 for reflecting the reflection beams reflected by the reflective region 602. Specifically, the reflective region 602 of the aperture-coupled mirror 60 reflects the reflection beams to the receiver mirror 50, which reflects the received reflection beams to the corresponding receiver 302. By providing the receiver mirror 50, the disclosure causes the reflection beams focused by the lens assembly 20 to enter the receiver 302 after two reflections, increasing the length of the reception path to facilitate the receiver 302 to receive the light spot.

It is apparent to those skilled in the art that various modifications and variations can be made to the disclosure without departing from the spirit and scope thereof. Therefore, if these modifications and variations of the disclosure fall within the scope of the claims and their equivalents, the disclosure also intends to cover these modifications and variations.

The above-listed embodiments are merely preferred embodiments of the disclosure and cannot be used to limit the scope of the claims of the disclosure. Therefore, equivalent variations made according to the claims of the disclosure still fall within the scope covered by the disclosure.

1. A LiDAR device, comprising:
a housing; and
a transceiver, a lens assembly, a transmitter mirror, an aperture-coupled mirror, and a receiver mirror disposed inside the housing;
wherein:
the transceiver includes an emitter for emitting emission beams and a receiver for detecting reflection beams, the reflection beams being beams reflected back by a target object after the emission beams travel to the target object;
the transmitter mirror reflects the emission beams to the lens assembly;
the lens assembly collimates the emission beams into a collimated beams and focuses the reflection beams onto the aperture-coupled mirror;
the aperture-coupled mirror reflects the received reflection beams to the receiver mirror;
the receiver mirror reflects the reflection beams reflected by the aperture-coupled mirror to the receiver.

2. The LiDAR device according to claim 1, wherein the aperture-coupled mirror comprises a transparent region, and a reflective region, a part of the aperture-coupled mirror that is not transparent is the reflective region; the transparent region transmits the emission beams reflected by the transmitter mirror, and the reflective region reflects the reflection beams focused by the lens assembly.

3. The LiDAR device according to claim 2, wherein a transmission range of the transparent region corresponds to that of the emission beams reflected by the transmitter mirror.

4. The LiDAR device according to claim 3, wherein the transparent region is strip-shaped, and a length of the transparent region is about 99 mm~101 mm.

5. The LiDAR device according to claim 1, wherein the lens assembly comprises a plurality of spaced lenses arranged concentrically.

6. The LiDAR device according to claim 1, wherein an entire surface of the lens assembly is illuminated by the emission beams.

7. The LiDAR device according to claim 1, wherein the LiDAR device is a single-lens LiDAR device, a focal length of the lens assembly is about 214 mm~216 mm, and a thickness of the lens assembly is about 74 mm~76 mm.

8. The LiDAR device according to claim 1, wherein the transceiver is a coaxial transceiver.

9. The LiDAR device according to claim 1, wherein the emitter is one or more, the receiver is one or more, and the emission beams emitted by the emitter are detected only by the corresponding receiver.

10. A equipment, comprises:
a main body; and
aLiDAR device, theLiDAR device, comprising:
a housing; and
a transceiver, a lens assembly, an transmitter mirror, an aperture-coupled mirror, and a receiver mirror disposed inside the housing;
wherein:
the transceiver includes an emitter for emitting emission beams and a receiver for detecting reflection beams, the reflection beams being beams reflected back by a target object after the emission beams travel to the target object;
the transmitter mirror reflects the emission beams to the lens assembly;
the lens assembly collimates the emission beams into collimated beams and focuses the reflection beams onto the aperture-coupled mirror;
the aperture-coupled mirror reflects the received reflection beams to the receiver mirror;
the receiver mirror reflects the reflection beams reflected by the aperture-coupled mirror to the receiver.

11. The equipment according to claim 10, wherein the aperture-coupled mirror comprises a transparent region, and a reflective region, a part of the aperture-coupled mirror that is not transparent is the reflective region; the transparent region transmits the emission beams reflected by the transmitter mirror, and the reflective region reflects the reflection beams focused by the lens assembly.

12. The equipment according to claim 11, wherein a transmission range of the transparent region corresponds to that of the emission beams reflected by the transmitter mirror.

13. The equipment according to claim 12, wherein the transparent region is strip-shaped, and a length of the transparent region is about 99 mm~101 mm.

14. The equipment according to claim 10, wherein the lens assembly comprises a plurality of spaced lenses arranged concentrically.

15. The equipment according to claim 10, wherein an entire surface of the lens assembly is illuminated by the incoming beams.

16. The equipment according to claim 10, wherein the LiDAR device is a single-lens LiDAR device, a focal length of the lens assembly is about 214 mm~216 mm, and a thickness of the lens assembly is about 74 mm~76 mm.

17. The equipment according to claim 10, wherein the transceiver is a coaxial transceiver.

18. The equipment according to claim 10, wherein the emitter is one or more, the receiver is one or more, and the emission beams emitted by the emitter are detected only by the corresponding receiver.

19. A LiDAR device, comprising:
a transceiver, including an emitter for emitting emission beams, and a receiver for detecting reflection beams, the reflection beams being beams reflected back by a target object after the emission beams travel to the target object;
a transmitter mirror, reflects the emission beams to the lens assembly;
a lens assembly, collimates the emission beams into a collimated beams and focuses the reflection beams onto the aperture-coupled mirror;
an aperture-coupled mirror, reflects the received reflection beams to the receiver mirror; and
a receiver mirror, reflects the reflection beams reflected by the aperture-coupled mirror to the receiver.

20. The LiDAR device according to claim 1, wherein the aperture-coupled mirror comprises a transparent region, and a reflective region, a part of the aperture-coupled mirror that is not transparent is the reflective region; the transparent region transmits the emission beams reflected by the transmitter mirror, and the reflective region reflects the reflection beams focused by the lens assembly.
